(19) United States
(12) Patent Application Publication
(10) Pub. No.: US 2026/0029359 A1
(43) Pub. Date: Jan. 29, 2026

(54) ADAPTIVE COUNT RATE MODULATION TO INCREASE DEPTH PROFILE DYNAMIC RANGE IN SECONDARY ION MASS SPECTROSCOPY

(71) Applicant: NOVA MEASURING INSTRUMENTS INC., Fremont, CA (US)

(72) Inventors: Bruno W. SCHUELER, San Jose, CA (US); Gabor TOTH, San Jose, CA (US)

(73) Assignee: NOVA MEASURING INSTRUMENTS INC., Fremont, CA (US)

(21) Appl. No.: 18/994,032

(22) PCT Filed: Dec. 29, 2022
(86) PCT No.: PCT/IB2022/062895

§ 371 Date: Jan. 14, 2025

Related U.S. Application Data
(60) Provisional application No. 63/368,662, filed on Jul. 17, 2022.

(51) Int. Cl. G01N 23/2258; H01J 49/00; H01J 49/02

(52) U.S. Cl. CPC G01N 23/2258; H01J 49/0031; H01J 49/025

(57) ABSTRACT

A method for adaptive secondary ion mass spectroscopy, the method may include (a) adaptively setting a detection parameter that impacts an instantaneous count rate of a detector; (b) scanning an evaluated sample with a focused primary ion beam; (c) sensing, by the detector, secondary ions ejected due to the scanning, to provide detection signals; and (d) analyzing a composition of the evaluated sample based on (i) the detection signals, and (ii) a mapping between values of the detection parameter and the instantaneous count rate of the detector.

### CROSS-REFERENCE TO RELATED APPLICATIONS

The application claims the benefit from U.S. provisional application No. 63/368,662, filed Jul. 17, 2022, the entire contents of which are incorporated by reference.

### BACKGROUND

Secondary-ion mass spectrometry (SIMS) is a technique used to analyze the composition of evaluated samples such as solid surfaces and thin films by sputtering the surface of the evaluated sample with a primary ion beam and collecting and analyzing ejected secondary ions.

Detectors such as electron multipliers are used to detect the secondary ions but have a finite dynamic range—and they are capable to receiving up to a certain number of counts per second before being saturated. SUMMARY

There are provided systems, method and non-transitory computer readable medium for adaptive SIMS.

### BRIEF DESCRIPTION OF THE DRAWINGS

Aspects, will be understood and appreciated more fully from the following detailed description taken in conjunction with the appended drawings in which:

FIG. 1 illustrates an example of a SIMS system;

FIG. 2 illustrates an example of a detector collection efficiency under a certain bias voltage;

FIG. 3 illustrates an example of a detector collection efficiency under another bias voltage;

FIG. 4 illustrates an example of a detector;

FIG. 5 illustrates an example of a detector;

FIG. 6 illustrates an example of a group of detectors; and

FIG. 7 illustrates an example of a method.

### DETAILED DESCRIPTION

There may be provided a method that may increase the dynamic range of a secondary ion detector such as an electron multiplier that is preceded by a dynode.

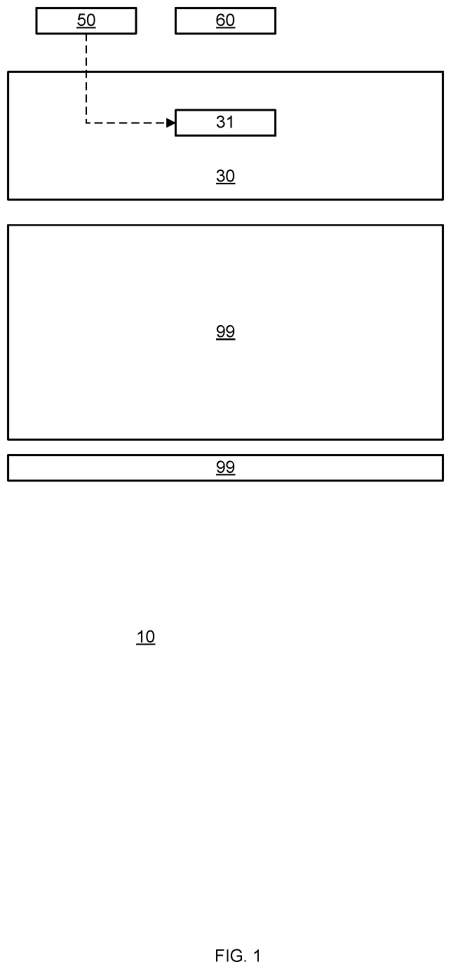

FIG. 1 illustrates an example of an adaptive SIMS system 10 that may include ion optics 20, a detection unit 30 that includes one or more detectors such as detector 31, a controller 50, and an analyzer 60.

The ion optics 20 is configured to scan an evaluated sample 99 with a primary ion beam.

The controller 50 is configured to set a detection parameter that impacts an instantaneous count rate (ICR) of the detector. The value of the detection parameter may change over time.

The detector 31 is configured to sense secondary ions ejected due to the scanning, to provide detection signals.

The analyzer is configured to analyze a composition of the evaluated sample based on (i) the detection signals, and (ii) a mapping between an impact of the detection parameter on an ICR of the detector. The analysis may be a depth profile analysis or any other analysis related to the evaluated sample.

The analysis applied by the analyzer may attempt to compensate for changes of a value of the detection parameter during the scanning of the evaluated sample.

Assuming, for example, that (i) a first area of the evaluated sample was scanned while applying a detection parameter of a first value that results in a first ICR of the detector, and that (ii) a second area of the evaluated sample was scanned while applying a detection parameter of a second value that results in a second ICR of the detector. Under this assumption the analysis has to compensate for the differences between the first and second ICRs of the detector.

One SIMS system may differ from another SIMS system—and is it beneficial to determine a mapping per SIMS system. The mapping may include performing a calibration process during which a test sample of a known composition is illuminated with a primary ion beam while applying a detection parameter of different values. The test sample or one or more areas of the test sample may be scanned multiple times—for evaluating different values of the detection parameter.

A SIMS system may undergo a calibration process multiple times—at different points in time—for compensating for changes in the SIMS system.

The detection parameter may be an intensity parameter that may be indicative of gain (positive or negative) to be applied on the secondary ions before reaching the detector. The detection may be referred to mass spectrometry. See, for example U.S. Pat. No. 10,910,208 which is incorporated herein by reference.

The detection parameter may indicate, for example, a suppression applied on secondary electrons that reach a detection path of the detector. The detection path may include a mass defining aperture.

The detection parameter may be indicative of the sensitivity of the detector. The detection parameter may be a collection efficiency of the detector.

The detection parameter may be a value of a bias signal that biases the detector or any components that precedes the detector.

The value of the detection parameter may change during a scanning of an evaluated object. For example—the value (of the detection parameter) at one point of time may impact the value of the detection parameter at a further point of time during the scanning.

The value of the detection parameter may be determined (at least in part) based on one or more ion optics parameters and/or may be determined (at least in part) on one or more evaluated sample parameters.

The evaluated sample parameter may be known or measured or may be estimated in any manner.

An ion optics parameter may be the intensity and/or current and/or energy and/or focus and/or cross section of the primary ion beam—or any other aspect of an illumination portion of the electron optics.

An evaluated sample parameter may be the composition of the evaluated sample—especially compositions of different locations of the evaluate sample.

The detection parameter may be a collection efficiency of the detector or a value of a bias voltage supplied to a dynode that is upstream to an electron detector. In this case the calibration process may include illuminating a test sample of a known composition while providing different dynode biases.

During the calibration process a rate of changes of the bias value may or may not exceed a rate of changes of the bias value during the scanning of the area of the surface of the evaluated sample.

During the calibration process the bias voltage may be changed by first steps. The scanning of the evaluated sample may include changing, during the scanning, the bias voltage by second steps. A first step may or may not exceed a second step.

While FIG. 1 illustrates a single detector, the detection unit 30 may include a group of detectors.

During an evaluation of one or more areas of an evaluated sample, all the detectors of the group may be activated to sense secondary ions that are emitted from the one or more areas of evaluated sample.

Alternatively, only some of the detectors of the group may be selected to sense secondary ions emitted from one or more areas of the evaluated sample.

Any selection process may be applied to select the one or more selected detectors.

A non-selected detector may be shut down or have its collection efficiency reduced below a certain threshold. For example—secondary ions that reach a mass defining aperture of an unselected detector may be suppressed below a threshold such as a detection threshold of the detector.

The detection and analysis may be applied individually on each selected detector.

At least two detectors of the group may receive secondary ions emitted at different directions. At least two other detectors of the group may receive secondary ions that ejected at the same direction but were split an one or more elements of the electron optics.

The detectors of the group of detectors have fields of view—a field of view per detector. The fields of view of two or more detectors may partially overlap, may fully overlap or may not overlap.

In some of the following examples is it assumed that the detection parameter is a value of a dynode bias provided to a dynode.

Instead of maintaining the detection parameter fixed (for example setting the dynode bias to a fixed value that optimizes collection efficiency), the dynode bias is dynamically changed—for example to provide different ICR values.

The calibration process may include building a mapping by measuring the ICR values obtained for different dynode bias values—while illuminating a test sample of known composition—for example—a bulk sample (a silicon made sample).

A mapping (such as a calibration matrix of dynode bias per ICR) can be generated and stored.

One or more mappings may be provided for different ion optics parameter values or for different sample parameter values, or for different combinations of ion optics parameter values and different sample parameter values.

During a scanning of an evaluated sample, the one or more values of the detection parameter that were applied during the scanning are recorded and are used during the analysis of the composition of the evaluated sample.

The changing of the detection parameter facilitates using a universal relative sensitivity factor (RSF) at virtually any ICR value without the need to re-verify the RSF for a material dopant.

Changing the detection parameter as described above avoids errors in quantification during a depth profile analysis when one or more detectors experience counts rates exceeding the linear response.

The yield of different materials may differ from each other by multiple orders. The setting of the detection parameter, when taking into account the composition of the evaluated sample, may prevent saturation of the detector and may dramatically increase the dynamic range of the detector.

An example of a determination of a depth profile of an evaluated sample is illustrated below and involves using a SIMS depth profiling system that automatically records ICR versus time (for multiple detectors). For a pre-determined maximal ICR (depending on the primary ion beam current and secondary ion yield), the following steps can be applied:
a. Adjust the detector collection efficiency, i.e., via dynode bias, for ICRs approximately 2-5× below the maximal ICR criterion at the beginning of the depth profile. This setting may be highly dependent on the primary ion beam current.
b. Monitor the ICR during the depth profile via a data acquisition counter system.
c. Once the ICR drops below a predefined relative value where the counting statistics result in a predefined loss of precision, automatically change the collection efficiency of the detector (i.e., via dynode bias) to increase the ICR to a higher level and store the updated detection parameter in a data stream. The increase of detector efficiency can be applied in steps of one, two, or three decades—depending on a preprogrammed criterion. Any change of the detector efficiency can be post-processed and corrected for by applying the calibration matrix (dynode bias vs. ICR) at the end of the depth profile via post processing.

The change in the value of the dynode bias may be conditioned in maintaining at least a predefined number of images that trigger the change. A hysteresis may be applied on the decision to change the value of the dynode bias.

Note that the criterion for changing a detector collection efficiency may be either a decrease or an increase in—for example in dynode bias/detector collection efficiency—if the ICR exceeds a predefined limit or falls below (or rises above) a relative count rate criterion.

The mapping can be of any resolution—for example—different resolution levels may include steps of 2 (or other value) ICR suppression change (for example—start by a applying a first suppression value, then perform another scan with a second suppression value that is twice the first suppression value, and repeat multiple times) in order to provide sufficient data density for actual depth profile post-depth profile correction for one or more detectors used in the system. During the analyzing, an inverse mapping may be applied.

If, for example, an initial ICR exceeds a predefined value (for example—a deadtime limit), the ICR may be decreased by a predefined factor—for example to prevent saturation of the detector.

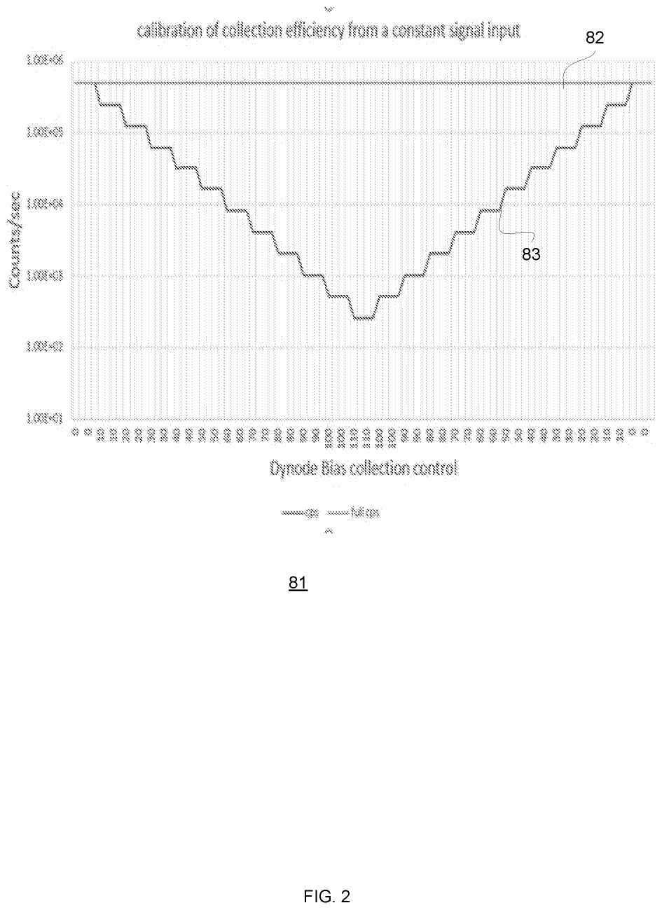

FIG. 2 illustrates an example 81 of a detector collection efficiency under a certain bias voltage. Line 82 illustrates a dynode bias that results in a maximal ICR value while curve 83 illustrates different dynode bias values.

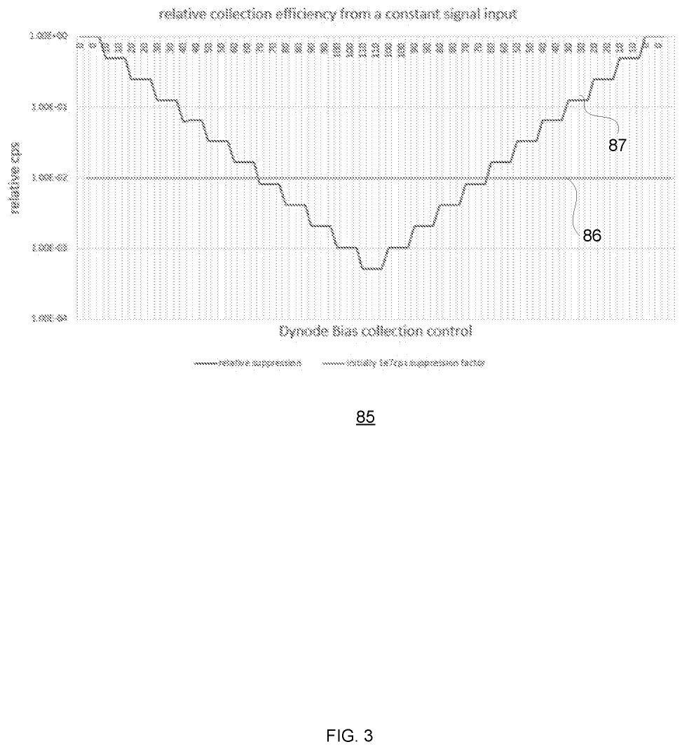

FIG. 3 illustrates an example 85 of a detector collection efficiency under another bias voltage. Line 86 illustrates an initial dynode bias that results in a certain ICR value while curve 87 illustrates different dynode bias values.

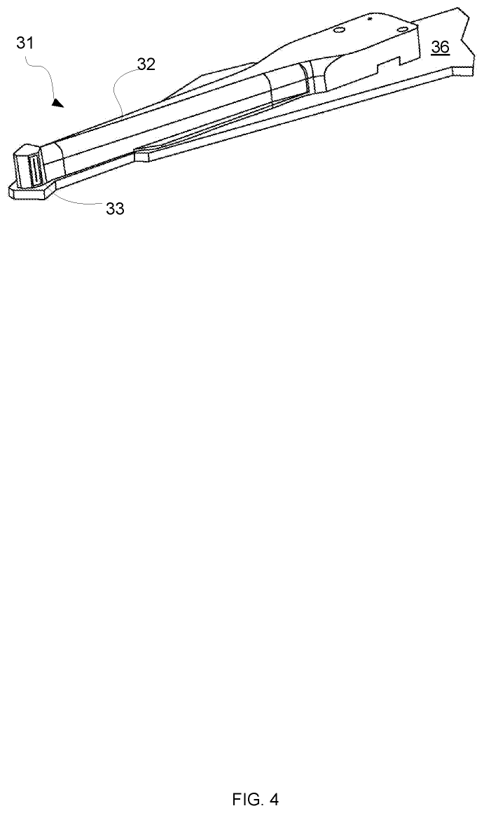

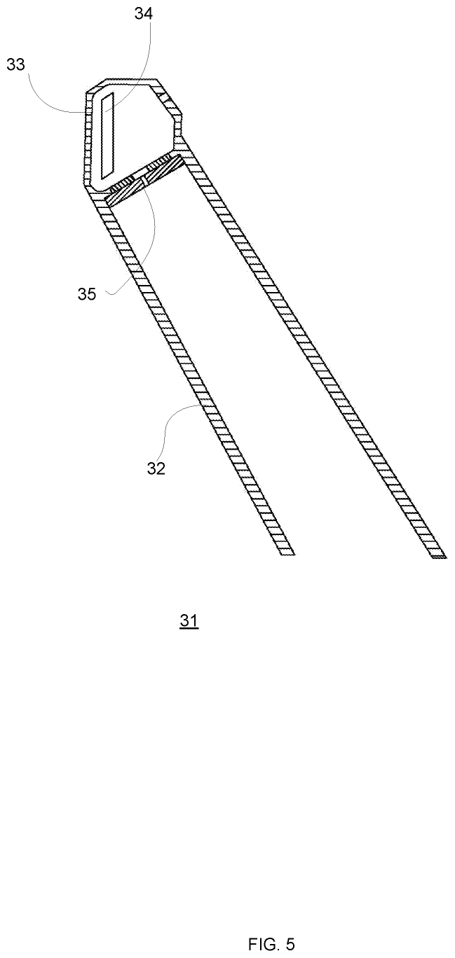

FIGS. 4 and 5 illustrate an example of a detector 31. The detector includes a housing 32, a mass defining aperture 33 through which the secondary ions propagate before impinging on the dynode (denoted 34 in FIG. 5), and electron detector (denoted 35 in FIG. 5). FIG. 5 may illustrate only the aperture of the electron detector—and the electron detector may span within the housing 32. The electron detector may be supported by a mechanical support element such as base (denoted 36 in FIG. 4).

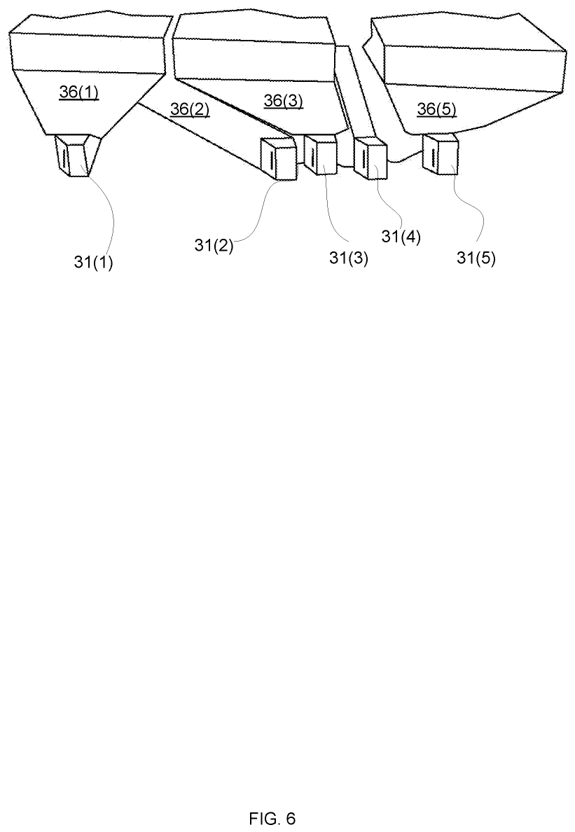

FIG. 6 illustrates a group of detectors that includes first detector 31(1), second detector 31(2), third detector 31(3), fourth detector 31(4) and fifth detector 31(5). FIG. 6 also illustrates some of the bases—first base 36(1), second base 36(2), third base 36(3) and fifth base 36(5).

During a scanning of an area of a sample, a single detector, some of the detectors or all of the detectors may be selected to sense secondary ions.

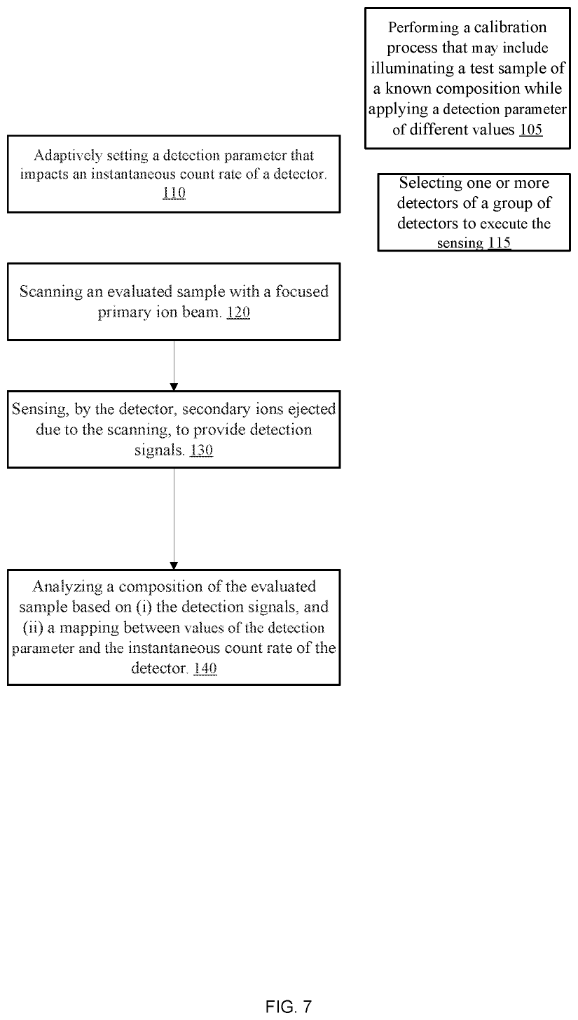

FIG. 7 illustrate an example of method 100.

Method 100 may start by step 110 of adaptively setting a detection parameter that impacts an instantaneous count rate of a detector. The setting may change between one scan of an evaluated object to another and may even change during a scanning of a single evaluated sample.

Step 110 may be executed in parallel to steps 120 and 130.

Step 120 may include scanning an evaluated sample with a focused primary ion beam. The scanning may “cover” one or more areas of the evaluated sample, the entire evaluated sample, and the like.

Step 120 may be executed during a scan period. It should be noted that at least one detection parameter that is applied during a first point of time of the scan period may be based on one or more detection signals obtained during a point in time that precedes the first point in time.

Step 110 may include obtaining an estimate of a composition of the evaluated sample, and wherein the setting is based, at least in part, on the estimate. Step 110 may also include evaluating an expected instantaneous count rate of the detector to be obtained without the setting, wherein the evaluating is based on the composition of the evaluated sample.

Step 130 may include sensing, by the detector, secondary ions ejected due to the scanning, to provide detection signals.

Step 130 may be followed by step 140 of analyzing a composition of the evaluated sample based on (i) the detection signals, and (ii) a mapping between values of the detection parameter and the instantaneous count rate of the detector.

If the detection parameter was changed according to a certain change pattern during the scanning then an inverse change pattern may be applied during the analyzing. The analyzing should compensate for any changes in the detection parameter that were applied during the scanning.

Step 130 may be executed (for example in parallel) by a group of detectors—and in this case the analyzing of step 140 may be responsive to the detection signals of the group of detectors.

Steps 130 and 140 may be preformed per each detector. Alternatively—an analysis may be based on detection signals sensed by two or more detectors.

When the SIMS system that executed method 100 include a group of detectors—method 100 may include step 115 of selecting one or more detectors of a group of detectors to execute step 130—while one or more unselected detectors may be idle, may be ignored of or may be biased to has a very low sensitivity.

The selection may change during the scanning or may maintain unchanged during a scanning of an evaluated sample.

Method 100 may include step 105 of performing a calibration process that may include illuminating a test sample of a known composition while applying a detection parameter of different values. Alternatively—method 100 may include receiving a mapping based on a calibration process.

The calibration process may include illuminating a test sample of a known composition while providing different bias values to the dynode.

A rate of changes of the bias value during the calibration process may or may not exceed a rate of changes of the bias value during the scanning of the area of the surface of the evaluated sample.

During the calibration process the bias voltage may be changed by first steps. Step 120 may include changing, during the scanning, the bias voltage by second steps. A first step may or may not exceed a second step.

The following is an example of a scanning of an evaluated object.
a. Set the detection parameter to a value.
b. Perform a part of a scanning of evaluated sample while applying the value. Detect secondary electrons by one or more detectors. Store detection signals and the value of the detection parameter. Optionally monitor the IPR.
c. Determine to change the value of the detection parameter, changing the value, and jump to step b in which a new part of the scanning is executed.
d. When the scanning end perform an analysis of the sampled sample using the detection signals obtained from different parts of the scanning, values of the detection parameter during different parts of the scanning and mapping.

Step (c) may be responsive to values of the ICR, to changes in an composition of a part of the evaluated sample, and the like.

Any aspect, described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects, are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. For example, the systems and methods described herein are applicable to any type of structure on semiconductor wafers. Many modifications and variations will be apparent to those of ordinary skill in the art without departing from the scope and spirit of the described embodiments.

We claim:

1-31. (canceled)

32. An adaptive secondary ion mass spectroscopy (SIMS) system, the SIMS system comprises:
ion optics that is configured to scan an evaluated sample with a focused primary ion beam;
a detector;
a controller that is configured to set a detection parameter that impacts an instantaneous count rate of the detector;
wherein the detector is configured to sense secondary ions ejected due to the scanning; and an analyzer that is configured to analyze a composition of the evaluated sample based on (i) the detection signals, and (ii) a mapping between values of the detection parameter and the instantaneous count rate of the detector.

33. The adaptive SIMS system according to claim 32 comprising a group of detectors that are configured to sense secondary electrons that are ejected due to the scanning and are within the fields of view of the detectors.

34. The adaptive SIMS system according to claim 33 wherein the analyzer is configured to analyze a composition of the evaluate sample based on secondary electrons sensed by two or more detectors of the group.

35. The adaptive SIMS system according to claim 33 wherein the controller is configured to select one or more detectors of the group to provide one or more selected detectors, and apply a sensing and an analyzing individually to the one or more selected detectors.

36. The adaptive SIMS system according to claim 35 wherein the controller is configured to suppress secondary ions that reach a detection path of an unselected detector of the group.

37. The adaptive SIMS system according to claim 32 wherein the detection parameter determines a collection efficiency of the detector.

38. The adaptive SIMS system according to claim 32 wherein the mapping is based on a calibration process that comprises illuminating a test sample of a known composition while applying a detection parameter of different values.

39. The adaptive SIMS system according to claim 32 wherein the controller is configured to change a collection efficiency of the detector by biasing a dynode that is upstream to the detector.

40. 25. The adaptive SIMS system according to claim 38 wherein the mapping is based on a calibration process that comprises illuminating a test sample of a known composition while providing different bias values to the dynode.

41. The adaptive SIMS system according to claim 38 wherein a rate of changes of the bias value during the calibration process does not exceed a rate of changes of the bias value during the scanning of the area of the surface of the evaluated sample.

42. The adaptive SIMS system according to claim 38 wherein during the calibration process the bias voltage is changed by first steps; and wherein the controller is configured to change, during the scanning, the bias voltage by second steps.

43. The adaptive SIMS system according to claim 42 wherein a first step does not exceed a second step.

44. The adaptive SIMS system according to claim 32 wherein a value of detection parameter is set based on an intensity of the focused primary ion beam.

45. The adaptive SIMS system according to claim 32 wherein a value of detection parameter is set based on an least one composition parameter of the evaluated sample.

46. The adaptive SIMS system according to claim 32 wherein the controller is configured to obtain an estimate of a composition of the evaluated sample, and wherein the setting is based, at least in part, on the estimate.

47. A method for adaptive secondary ion mass spectroscopy, the method comprises:
adaptively setting a detection parameter that impacts an instantaneous count rate of a detector;
scanning an evaluated sample with a focused primary ion beam; sensing, by the detector, secondary ions ejected due to the scanning, to provide detection signals; and
analyzing a composition of the evaluated sample based on (i) the detection signals, and (ii) a mapping between values of the detection parameter and the instantaneous count rate of the detector.

48. The method according to claim 47 wherein the sensing and the analyzing are applied individually to one or more detectors of a group of detectors, the group of detectors comprises the detector.

49. The method according to claim 47 comprising selecting one or more detectors of a group of detectors to provide one or more selected detectors and applying the sensing and the analyzing individually to the one or more selected detectors.

50. The method according to claim 49 comprising suppressing secondary ions that reach a detection path of an unselected detector of the group of detectors.

51. The method according to claim 32 wherein the adaptively setting comprises changing a collection efficiency of the detector by biasing a dynode that is upstream to the detector.
